(19) United States
(12) Patent Application Publication
(10) Pub. No.: US 2006/0140710 A1
(43) Pub. Date: Jun. 29, 2006

(54) Ball pin and ball joint comprising one such ball pin

(75) Inventors: Bruno Egner-Walter, Heilbronn (DE); Reinhard Edele, Bietigheim-Bissingen (DE)

Correspondence Address: Matthew R Jenkins;Jacox Meckstroth & Jenkins, 2310 Far Hills Building, Dayton, OH, 45419-1575, US

(73) Assignee: VALEO SYSTEMS D'ESSUYAGE

(21) Appl. No.: 10/537,937

(22) PCT Filed: Dec. 9, 2003
(86) PCT No.: PCT/EP03/13909

§ 371 Date: Jan. 19, 2006

(30) Foreign Application Priority Data
Dec. 9, 2002 (DE) 102 57 592.4

(51) Int. Cl. F16C 11/00

(52) U.S. Cl. 403/122

(57) ABSTRACT

A ball pin comprising a ball and a pin connected to the ball is characterized in that the ball is provided with a recess on its side facing away from the pin, the diameter of said recess corresponding approximately to the diameter of the pin.

The invention relates to a ball pin comprising a ball and a pin connected to the ball. The invention furthermore relates to a ball joint comprising such a ball pin and to an assembly consisting of two such ball joints.

Ball joints are used in many sectors. The present application relates in particular to the ball joints which are used in the drive mechanism for windscreen wipers of motor vehicles. Apart from the customary requirements with regard to freedom of play and service life, ball joints in windscreen wiper drives must have one particular feature: it is often desirable to have double ball joints, that is to say ball joints which have two balls lying next to one another. One example of such a double ball joint can be found in German laid-open specification 44 00 296, in which a second ball is glued or welded onto a first ball. On the other hand, in German laid-open specification 195 19 867, a single plastic part is used which has two spherical areas on its outer surface and is placed on a shaft made of metal.

The disadvantage of the known ball joints is that a very high outlay is required in order to obtain a double ball joint.

It is thus an object of the invention to provide a ball pin and a ball joint which can be used in a large number of applications in a flexible manner and with low outlay.

To this end, according to the invention, there is provided a ball pin comprising a ball and a pin connected to the ball, which is characterized in that the ball is provided with a recess on its side facing away from the pin, the diameter of said recess corresponding approximately to the diameter of the pin. This makes it possible to combine two ball pins with one another, wherein the pin of one ball pin is inserted in the recess of the other ball pin. A double ball joint is thus obtained with low outlay. Another advantage of the recess provided in the ball is that the ball pin has a lower weight.

Preferably, the pin is provided with knurling so that it can be pressed into the recess of the second ball pin without any play. Given suitable dimensioning, a press fit is obtained which is sufficient for joining the two ball pins.

According to the invention, there is also provided a ball joint comprising a ball pin with a recess, characterized in that the ball cup is injected into a connecting part, for example a rod of the drive mechanism of the windscreen wiper. In this way, the maximum number of assembly steps are saved.

According to one preferred embodiment of the invention, there is a ball cup made of plastic which is injected onto the ball. In this way, the ball cup can be fitted on the ball without play. Since the ball cup does not have to be pushed onto the ball, two further advantages are obtained: firstly, the ball cup can further enclose the ball so that a higher load ratio is obtained. This makes it possible to use balls of smaller diameter. Secondly, there is no need for the otherwise customary bellows seals, since the ball cup bears against the ball with a closed peripheral edge and thus forms a complete seal. The entry of particles of dirt is prevented in this way. If a suitable material is selected for the ball cup, for example POM with a slip additive, there may be no need for lubrication.

In order to meet increased sealing requirements, a seal may be provided which acts on the ball cup, for example in a groove.

According to one preferred embodiment of the invention, the seal has an anchoring section which is arranged in the recess and a circular or annular sealing section which bears against the ball cup. Since the anchoring section can be inserted deep into the recess in the ball pin, the seal is reliably held on the ball pin.

According to one preferred embodiment of the invention, there is a stop which engages in the recess and defines the maximum possible movement of the ball cup relative to the ball. In this way, a very compact stop is obtained which at the same time can withstand high loads. The stop is preferably made in one piece with the ball cup.

The invention will be described below with reference to various embodiments which are shown in the appended drawings. In said drawings:

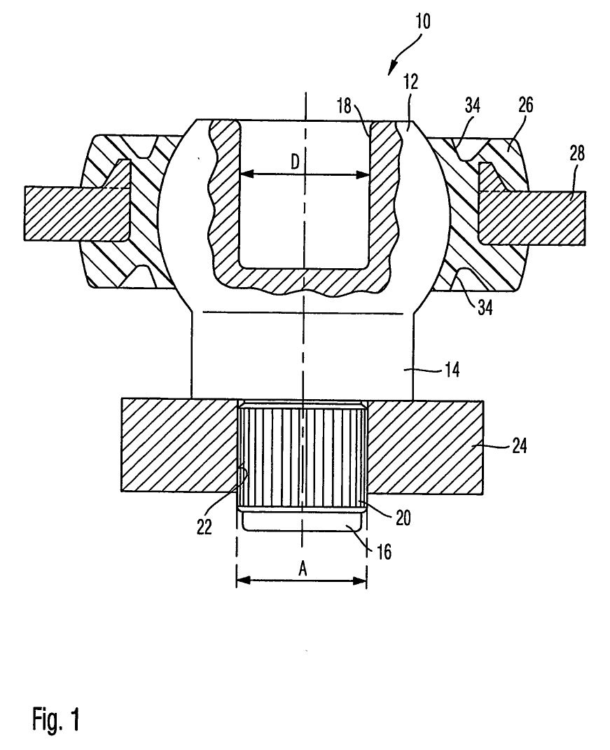

FIG. 1 shows in a sectional view a ball joint according to a first embodiment;

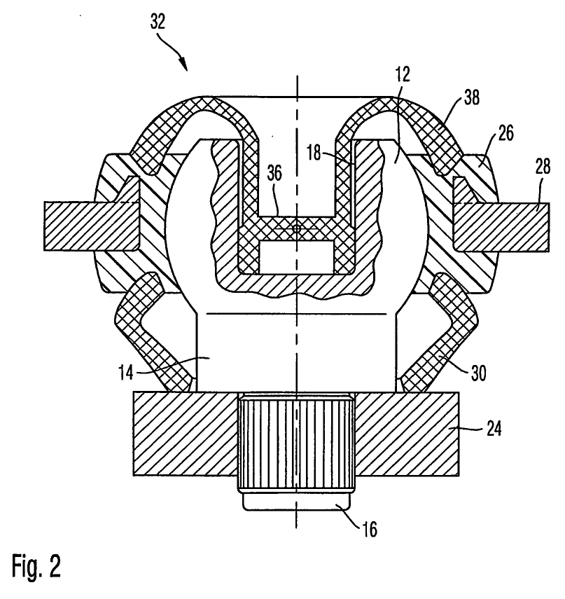

FIG. 2 shows in a sectional view a ball joint according to a second embodiment;

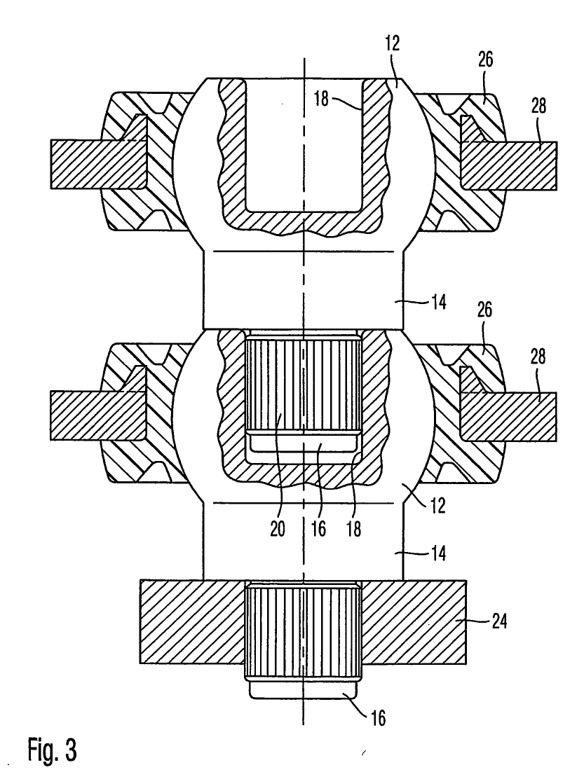

FIG. 3 shows a first assembly consisting of two ball joints;

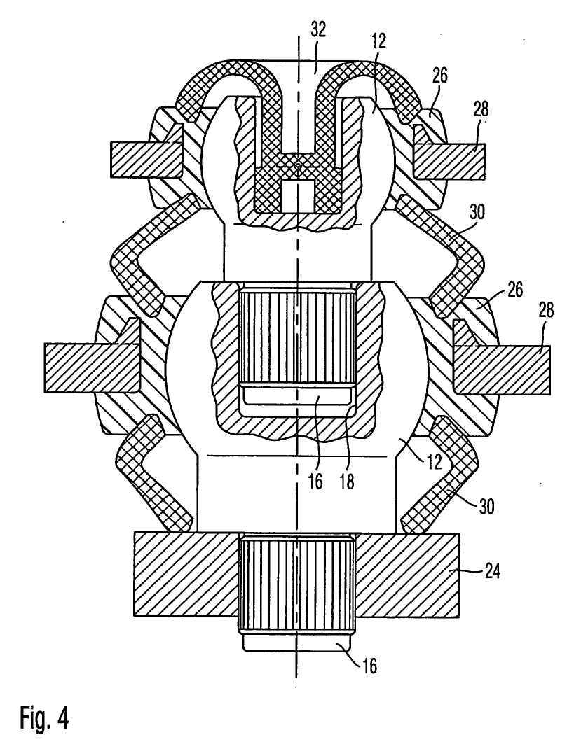

FIG. 4 shows a second assembly consisting of two ball joints; and

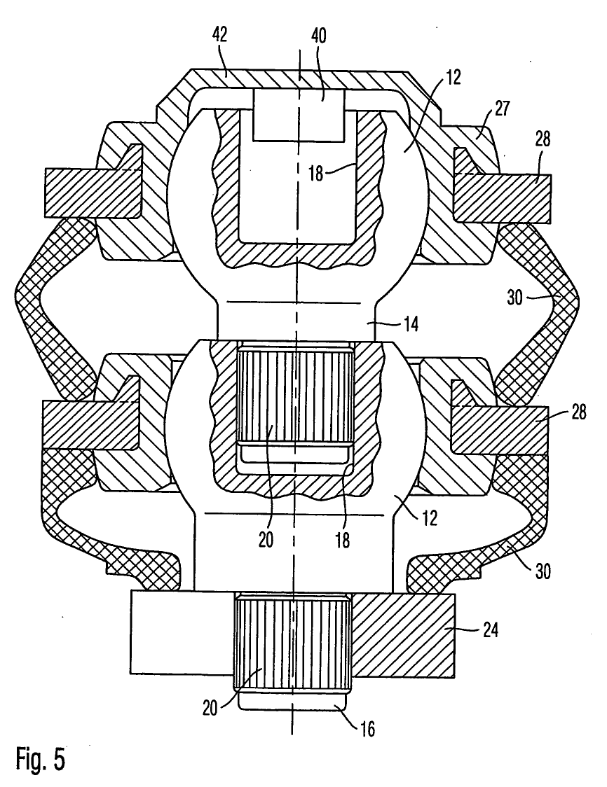

FIG. 5 shows a third assembly consisting of two ball joints.

FIG. 1 shows a ball pin 10 which consists of a ball 12, an intermediate section 14 and a pin 16. The ball 12, the intermediate section 14 and the pin 16 are made in one piece from metal.

The ball 12 has a recess 18 on its side facing away from the pin 16, said recess being designed as a blind hole. The depth of the recess 18 corresponds to approximately 34 of the height of the ball 12. The internal diameter D of the recess 18 corresponds approximately to the external diameter A of the pin 16. The latter is provided with knurling 20, by means of which it is pressed into a hole 22 in a base part 24 without any play.

A ball cup 26 is arranged on the ball 12, said ball cup being an injection-moulded part made of POM.

The ball cup 26 is injected directly onto the ball 12 and at the same time is injected into a cut-out of a rod 28. The rod 28 forms part of the drive mechanism for a windscreen wiper. Since the ball cup 26 is injected onto the ball 12 of the ball pin 10, it bears against the ball without any play.

FIG. 2 shows a ball joint as known in principle from FIG. 1. The difference with respect to the embodiment of FIG. 1 is that two seals 30, 32 are provided. The seal 30 is designed as an annular bellows which rests with its upper edge in FIG. 2 in a groove 34 (cf. FIG. 1) in the ball cup 26, and with its lower edge in FIG. 2 on the base part 24. The seal 32 has an anchoring section 36 which is inserted in the recess 18 of the ball 12, and a sealing section 38 which is formed in one piece with the anchoring section and engages in a second groove 34 of the ball cup 26. The ball joint is thus sealed all the way round.

FIG. 3 shows an assembly which consists of two ball joints 10 as known from FIG. 1. The upper ball joint in FIG. 3 is fixed to the lower ball joint by the pin 16 of the upper ball joint being pushed into the recess 18 of the lower ball joint. Since the knurling 20 of the pin 16 has a slightly greater diameter than the recess 18, a press fit is obtained, by virtue of which the pin 16 is accommodated in the recess 18 without any play.

FIG. 4 shows an assembly which is obtained by combining two ball joints as shown in FIG. 2. One essential feature of the assembly shown in FIG. 4 is that in this case two ball joints of different diameter are combined with one another. The upper ball joint in FIG. 4 has a smaller ball diameter than the lower ball joint. However, regardless of their ball diameter, these ball joints can nevertheless be combined with one another since both the diameter of their pins 16 and the diameter of their recesses 18 are identical (with the exception of a possible overdimensioning of the pin in order to obtain a press fit). In this way, a large number of combination possibilities are obtained for a minimal assembly outlay.

FIG. 5 shows an assembly consisting of two ball joints. Unlike the ball joints shown in FIGS. 1 to 4, in the assembly shown in FIG. 5 use is made of ball cups 27 which are snapped onto the balls 12 of the ball pins 10. Another difference lies in the arrangement of the seals 30, 32. The latter do not engage in a groove of the corresponding ball cup but rather are supported between the rods 28 and between the rod 28 and the base part 24.

Another significant difference compared to the previous embodiments is that the ball cup 27 of the upper ball joint in FIG. 5 is provided with a stop 40 which is designed as a cylindrical protrusion on a bridge 42 formed in one piece with the ball cup 27, and which engages in the recess 18 of the ball 12 of the upper ball joint. In this way, the maximum rotation of the ball cup 27 and thus of the rod 28 relative to the upper ball joint is limited. At the same time, since the bridge 42 is closed, no seal is required on the upper side of the upper ball joint.

### LIST OF REFERENCES

10: ball pin
12: ball
14: intermediate section
16: pin
18: recess
20: knurling
22: hole
24: base part
26: ball cup
28: rod
30: seal
32: seal
34: groove
36: anchoring section
38: sealing section
40: stop
42: bridge

1. A ball pin comprising a ball and a pin connected to the ball, characterized in that the ball is provided with a recess on its side facing away from the pin, the diameter of said recess corresponding approximately to a diameter of the pin.

2. The ball pin according to claim 1, characterized in that the pin is provided with knurling so that it can be pressed into a recess of a second ball pin without any play.

3. A ball joint comprising a ball pin according to claim 1, characterized in that there is a ball cup made of plastic which is injected into a connecting part.

4. The ball joint according to claim 3, characterized in that the ball cup is injected onto the ball.

5. The ball joint according to claim 3, characterized in that there is a seal which acts upon the ball cup.

6. The ball joint according to claim 5, characterized in that the ball cup has a groove in which the seal is arranged.

7. The ball joint according to claim 1, characterized in that the seal has an anchoring section which is arranged in the recess and a circular or annular sealing section which bears against the ball cup.

8. The ball joint according to claim 3, characterized in that there is a stop which is situated in the recess and defines a maximum possible movement of the ball cup relative to the ball.

9. The ball joint according to claim 8, characterized in that the stop is made in one piece with the ball cup.

10. Assembly consisting of two ball joints according to claim 3, characterized in that a pin of said ball pin is fitted into a recess of a ball of a second ball pin.

11. A ball pin system comprising:
a first ball; and
a first pin integrally formed in said first ball;
said first ball comprising a first recess situated generally opposite first pin, said first recess being adapted to receive a second pin integrally formed in a second ball.

12. The ball pin system as recited in claim 1 wherein said second pin is knurled and press-fit into said first recess.

13. The ball pin system as recited in claim 1 wherein said first recess comprises a depth that is approximately three quarters the length of said first ball.

14. The ball pin system as recited in claim 1 wherein said ball pin system comprises said second ball having a second ball and said second pin integrally formed in said second ball and mounted into said recess.

15. The ball pin system as recited in claim 14 wherein said second ball comprises a second recess situated generally opposite said second pin; said first and second balls and said first and second recesses being generally co-axial when said second ball is mounted onto said first ball.

16. The ball pin system as recited in claim 1 wherein a ball cup is molded onto said first ball.

17. The ball pin system as recited in claim 16 wherein a ball cup comprises a stop that is received in said second recess to facilitate limiting a rotation of a rod coupled to said ball cup.

18. The ball pin system as recited in claim 14 wherein a ball cup is molded onto said second ball, said a ball cup comprising a stop that is received in said second recess to facilitate limiting a rotation of a rod coupled to said ball cup.

19. The ball pin system as recited in claim 14 wherein said first ball comprises a first diameter and said second ball comprises a second diameter, said first and second diameters being the same.

20. The ball pin system as recited in claim 14 wherein said first ball comprises a first diameter and said second ball comprises a second diameter, said first and second diameters being different.

21. The ball pin system as recited in claim 20 wherein said second diameter is smaller than said first diameter.

22. The ball pin system as recited in claim 14 wherein said first recess comprises a recess diameter that and said second pin comprises a pin diameter that generally corresponds to said recess diameter in order to enable a press fit of said second pin into said first recess.
